(19) United States
(12) Patent Application Publication
(10) Pub. No.: US 2004/0245785 A1
(43) Pub. Date: Dec. 9, 2004

(54) Electric door lock with a coupling mechanism for selective engagement between a deadbolt operating spindle and an electric driving motor unit

(76) Inventor: Fang-Kun Chen, Chia-Yi City (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/452,145

(22) Filed: Jun. 3, 2003

(51) Int. Cl. E05C 1/06

(52) U.S. Cl. 292/144

(57) ABSTRACT

An electric door lock includes a deadbolt, a spindle, an electric driving motor unit, and a coupling mechanism. The spindle is coupled to the deadbolt and is rotatable between a first position, where the deadbolt is at a locking position, and a second position, where the deadbolt is at an unlocking position. The coupling mechanism includes a driving member connected to the motor unit and a driven member connected to the spindle. The driving member is configured to engage the driven member so as to transmit rotary drive force of the motor unit to the spindle when the motor unit is operated for moving the spindle from the first position to the second position and vice versa, and is configured to disengage from the driven member when the spindle has been moved from the first position to the second position and vice versa.

### BACKGROUND OF THE INVENTION

1. Field of the Invention

The invention relates to an electric door lock, more particularly to an electric door lock with a coupling mechanism for selective engagement between a deadbolt operating spindle and an electric driving motor unit.

2. Description of the Related Art

In U.S. Pat. No. 6,471,257, there is disclosed an electric door lock that includes a deadbolt movable between locking and unlocking positions. A manual operating member has a spindle that is connected to the deadbolt, and a manually operable knob that is secured to one end of the spindle. A spindle coupling ring is sleeved on the spindle so as to be co-rotatable therewith, and has an outer peripheral surface formed with angularly displaced first locking grooves. A rotary seat has a gear portion that is sleeved rotatably on the spindle, and a clutch portion that is connected fixedly and co-axially to the gear portion. The clutch portion has an inner surface around the spindle coupling ring, and an outer surface opposite to the inner surface, and is formed with mounting holes which are aligned respectively with the first locking grooves in the spindle coupling ring. Each of the mounting holes has an open inner hole end formed in the inner surface, and an open outer hole end formed in the outer surface. A stationary seat has a ring portion which is disposed around the clutch portion and which has an annular inner peripheral surface confronting the outer surface of the clutch portion. The inner peripheral surface is formed with angularly displaced second locking grooves. Locking units are mounted respectively in the mounting holes. Each locking unit has a locking member and a compression spring. The locking member has an inner locking portion that is disposed at the inner hole end of the respective mounting hole, and an outer locking portion that is disposed at the outer hole end of the respective mounting hole. The compression spring is disposed to bias the locking member in a radial outward direction along the respective one of the mounting holes. Due to the biasing action of the compression spring, the locking member is normally disposed in a first position, in which the outer locking portion of the locking member projects radially and outwardly from the outer surface of the clutch portion and engages a respective one of the second locking grooves in the stationary seat for locking the rotary seat to the stationary seat, and in which the inner locking portion of the locking member is retracted into the mounting hole and is disengaged from a respective one of the first locking grooves in the spindle coupling ring for unlocking the rotary seat from the spindle coupling ring. The rotary knob is operable to rotate the spindle for moving the deadbolt between the locking and unlocking positions when the locking members are disposed in the first position. An electric driving motor has a transmission shaft coupled to the gear portion of the rotary seat, and is operable to drive rotation of the rotary seat for moving the locking members to a second position, in which the outer locking portion of the locking member of each of the locking units slides past the respective one of the second locking grooves and is disengaged from the respective one of the second locking grooves for unlocking the rotary seat from the stationary seat, and in which the inner locking portion of the locking member projects from the inner surface of the clutch portion and engages the respective one of the first locking grooves in the spindle coupling ring for locking the rotary seat to the spindle coupling ring, thereby enabling co-rotation of the spindle for moving the deadbolt between the locking and unlocking positions.

While the aforementioned conventional electric door lock achieves its intended purpose, it includes numerous components that give rise to inconvenience during assembly, and increased manufacturing costs. Furthermore, the conventional electric door lock includes the compression springs, the biasing action of which has to be overcome in order to rotate the clutch portion. This increases the load of the motor unit. As such, the power consumption of the conventional electric door lock is relatively high.

### SUMMARY OF THE INVENTION

Therefore, the main object of the present invention is to provide an electric door lock that can overcome the aforesaid drawbacks of the prior art.

According to the present invention, an electric door lock for a door panel comprises a deadbolt, a deadbolt operating spindle, a manual operating member, an electric driving motor unit, and a coupling mechanism. The deadbolt is adapted to be mounted on the door panel and is operable for movement between a locking position, where the deadbolt is extended relative to the door panel, and an unlocking position, where the deadbolt is retracted relative to the door panel. The spindle is coupled to the deadbolt and is rotatable between a first position, where the deadbolt is at the locking position, and a second position, where the deadbolt is at the unlocking position. The operating member is coupled to the spindle and is manually operable so as to drive rotation of the spindle. The motor unit is adapted to be mounted on the door panel and is operable so as to provide a rotary drive force. The coupling mechanism is adapted to be mounted on the door panel, and includes a driving member connected to the motor unit, and a driven member connected to the spindle. The driving member is configured to engage the driven member so as to transmit the rotary drive force of the motor unit to the spindle when the motor unit is operated for moving the spindle from one of the first and second positions to the ocher of the first and second positions, and is configured to disengage from the driven member when the spindle has been moved from one of the first and second positions to the other of the first and second positions.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the first preferred embodiment of an electric door lock according to the present invention;

FIG. 2 is a schematic view of the first preferred embodiment in an assembled state;

FIG. 3 is a schematic view to illustrate a spindle at a second position, and a sector gear disengaged from a toothed wheel;

FIG. 4 is a schematic view to illustrate the sector gear transmitting rotary drive force of a motor unit to the toothed wheel for driving rotation of the spindle;

FIG. 5 is a schematic view to illustrate the spindle at a first position, and the sector gear disengaged from the toothed wheel;

FIG. 6 is a schematic view to illustrate the spindle of FIG. 5 when driven after being rotated manually to the first position;

FIG. 7 is a perspective view of a sector gear formed integrally with a shaft of a gear wheel according to the second preferred embodiment of an electric door lock of this invention;

FIG. 8 is a schematic view to illustrate a switch actuator formed integrally with a toothed wheel according to the third preferred embodiment of an electric door lock of this invention;

FIG. 9 is a schematic view to illustrate a sector gear formed with first and second cutouts according to the fourth preferred embodiment of an electric door lock of this invention;

FIG. 10 is a schematic view to illustrate an urging unit provided on a sector gear and a gear wheel according to the fifth preferred embodiment of an electric door lock of this invention; and

FIG. 11 is a fragmentary sectional view of the fifth preferred embodiment.

### DETAILED DESCRIPTION OF THE PREFERRED EMBODIMENTS

Before the present invention is described in greater detail, it should be noted that like elements are denoted by the same reference numerals throughout the disclosure.

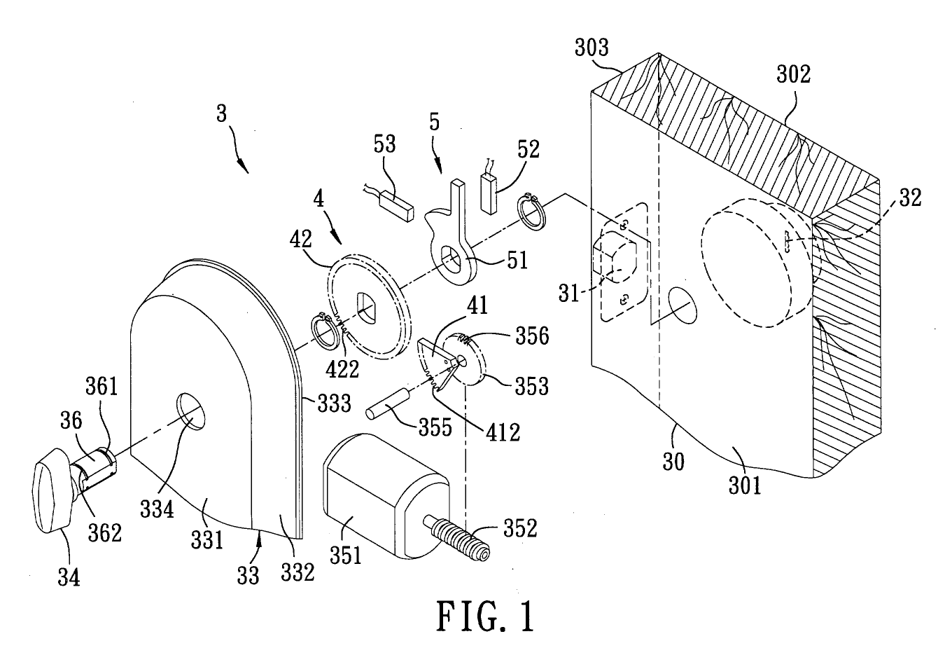

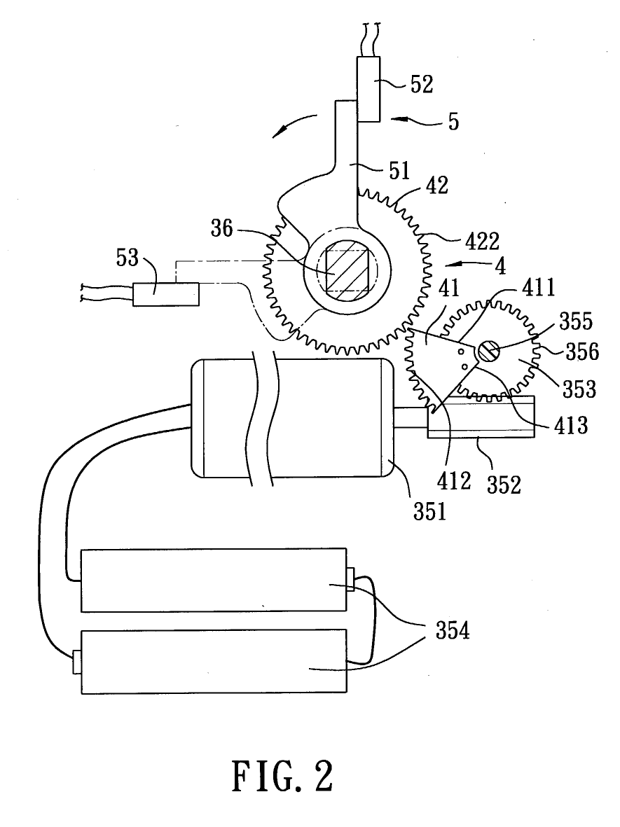

Referring to FIGS. 1 and 2, the first preferred embodiment of an electric door lock 3 for a door panel 30 according to this invention is shown to include a deadbolt 31, a deadbolt operating spindle 36, a manual operating member 34, an electric driving motor unit 351, and a coupling mechanism 4.

The door panel 30 has an inner surface 301, an outer surface 302, and a peripheral surface 303 that interconnects the inner and outer surfaces 301, 302.

A lock housing 33 is adapted to be mounted on the inner surface 301 of the door panel 30, and has a base wall 331 that is formed with a spindle hole 334 therethrough, and a surrounding wall 332 that extends from a periphery of the base wall 331. The base and surrounding walls 331, 332 cooperate to confine a cavity

The deadbolt 31 is adapted to be mounted on the door panel 30, and is operable for movement between a locking position, where the deadbolt 31 is extended relative to the peripheral surface 303 of the door panel 30, and an unlocking position, where the deadbolt 31 is retracted relative to the peripheral surface 303 of the door panel 30.

The spindle 36 extends rotatably into the lock housing 33 through the spindle hole 334. In particular, the spindle 36 has an inner end portion 361 disposed inwardly of the cavity 333 and an outer end portion 362 disposed externally of the lock housing 33. The inner end portion 361 of the spindle 36 is coupled to the deadbolt 31 such that the spindle 36 is rotatable between a first position, where the deadbolt 31 is at the locking position, and a second position, where the deadbolt 31 is at the unlocking position. In this embodiment, the first and second positions of the spindle 36 are angularly spaced apart from each other by an angle of 90 degrees.

The operating member 34 is coupled to the outer end portion 362 of the spindle 36 and is manually operable so as to drive rotation of the spindle 36 from one of the first and second positions to the other of the first and second positions.

In addition, a key-operated lock unit 32 is mounted on the outer surface 302 of the door panel 30, and is operable so as drive rotation of the spindle 36. Since the feature of the present invention does not reside in the particular configuration of the lock unit 32, which is conventional in construction, a detailed description of the same is omitted herein for the sake of brevity.

The motor unit 351 is mounted in the cavity 333 of the lock housing 33, is operable so as to provide a rotary drive force, and includes a gear wheel 353. The gear wheel 353 is mounted on a shaft 355 and has an outer peripheral edge 356 formed with gear teeth. The motor unit 351 further includes a transmission shaft 352 formed with a worm gear that meshes with the gear teeth of the gear wheel 353. A battery unit 354 is connected electrically to the motor unit 351 for providing electrical power to the latter.

The coupling mechanism 4 is mounted in the cavity 333 of the lock housing 33, and includes a driving member connected to the motor unit 351, and a driven member connected to the inner end portion 361 of the spindle 36. The driving member is configured to engage the driven member so as to transmit the rotary drive force of the motor unit 351 to the spindle 36 when the motor unit 351 is operated for driving rotation of the spindle 36 from one of the first and second positions to the other of the first and second positions, and is configured to disengage from the driven member when the spindle 36 has been rotated from one of the first and second positions to the other of the first and second positions. In particular, the driving member includes a sector gear 41. The sector gear 41 has first and second lateral sides 411, 413 spaced apart angularly from each other, and a curved peripheral side 412 formed with gear teeth. The first and second lateral sides 411, 413 of the sector gear 41 are spaced apart by an angle of 75 degrees. The sector gear 41 is mounted on the gear wheel 353 such that the sector gear 41 rotates coaxially with the gear wheel 353 and such that the curved peripheral side 412 of the sector gear 41 extends radially and outwardly beyond the outer peripheral edge 356 of the gear wheel 353. The driven member includes a toothed wheel 42 that is disposed to rotate with the spindle 36 and that has an annular outer peripheral surface 422 formed with gear teeth for meshing with the gear teeth of the sector gear 41.

In this embodiment, it is noted that the length of the curve peripheral side 412 of the sector gear 41 is less than one-fourth, preferably about one-fifth, of the length of the outer peripheral surface 422 of the toothed gear 42. Further, the radii of the sector gear 41 and the toothed wheel 42 are equal in length.

The electric door lock 3 further comprises control means 5 for controlling deactivation of the motor unit 351 when the spindle 36 has been moved from one of the first and second positions to the other of the first and second positions. In particular, the control means 5 includes first and second contact switches 53, 52 that are connected electrically to the motor unit 351, that are operable so as to deactivate the motor unit 351 when actuated, and that are angularly displaced from each other by an angle of 90 degrees. A switch actuator 51 is mounted on the inner end portion 361 of the spindle 36 for co-rotation therewith, is capable of actuating the first and second contact switches 53, 52, and includes a ring and an actuating arm that extends from a periphery of the ring. As such, as best shown in FIG. 2, when the spindle 36 is rotated from the second position to the first position, the actuating arm comes into contact with and actuates the first contact switch 53. Conversely, when the spindle 36 is rotated from the first position to the second position, the actuating arm comes into contact with and actuates the second contact switch 52.

It is noted that when the actuating arm of the switch actuator 51 has actuated one of the first and second contact switches 53, 52 to deactivate the motor unit 351, the transmission shaft 352 of the motor unit 351 continues to rotate momentarily due to the presence of inertial forces. This causes the sector gear 41 of the driving member to further rotate and to eventually disengage from the toothed wheel 42 of the driven member. Further, when the sector gear 41 of the driving member is disengaged from the toothed wheel 42 of the driven member, the operating member 34 can be operated manually to drive rotation of the spindle 36 from one of the first and second positions to the other of the first and second positions.

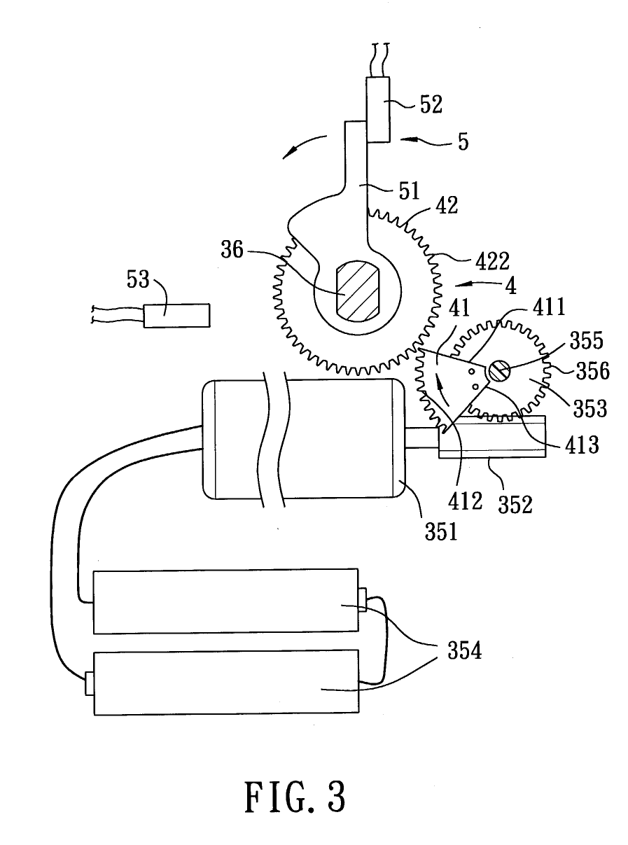

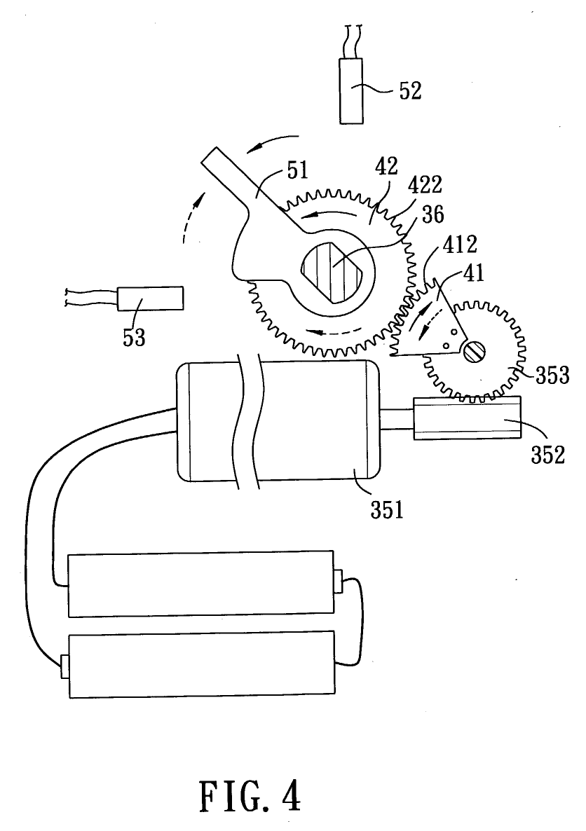

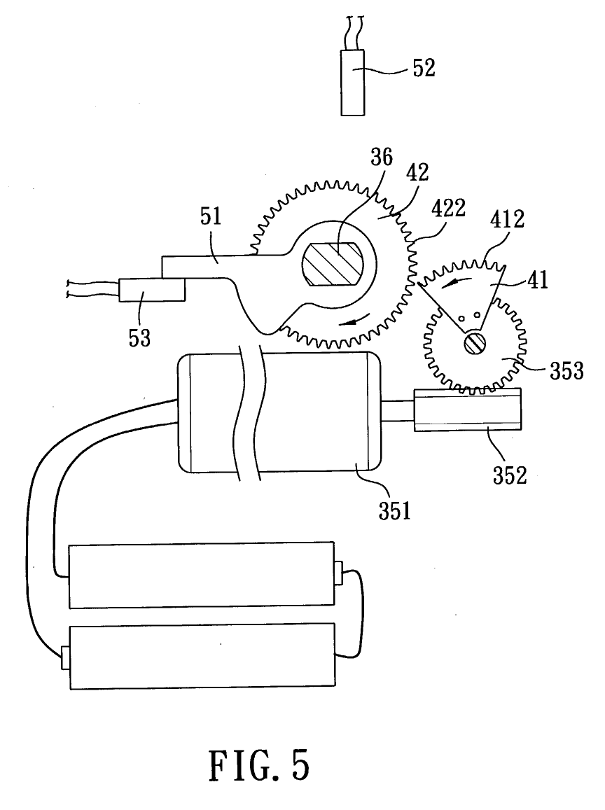

Referring to FIGS. 3 to 6, the motor unit 351 can be activated with the use of a remote controller (not shown) to drive rotation of the spindle 36 from one of the first and second positions to the other of the first and second positions. As best shown in FIG. 3, when the spindle 36 is in the second position, operation of the motor unit 351 results in clockwise rotation of the gear wheel 353 and in eventual engagement between the gear teeth of the sector gear 41 and the gear teeth of the toothed wheel 42, counter-clockwise rotation of the toothed wheel 42, and rotation of the spindle 36 to the second position, as best shown in FIG. 4. Subsequently, the actuating arm of the switch actuator 51 actuates the first contact switch 53 to deactivate the motor unit 351. Due to the aforesaid inertial forces, the sector gear 41 further rotates upon deactivation of the motor unit 351 to disengage completely from the toothed wheel 42, as best shown in FIG. 5.

Conversely, as best shown in FIG. 5, when the spindle 36 is in the second position, activation of the motor unit 351 results in counter-clockwise rotation of the gear wheel 353 and in eventual engagement between the gear teeth of the sector gear 41 and the gear teeth of the toothed wheel 42, clockwise rotation of the toothed wheel 42, and rotation of the spindle 36 back to the first position, as indicated by the phantom arrows in FIG. 4. Subsequently, the actuating arm of the switch actuator 51 actuates the first contact switch 53 to deactivate the motor unit 351. Likewise, due to the aforesaid inertial forces, the sector gear 41 further rotates upon deactivation of the motor unit 351 to disengage completely from the toothed wheel 42, as best shown in FIG. 3.

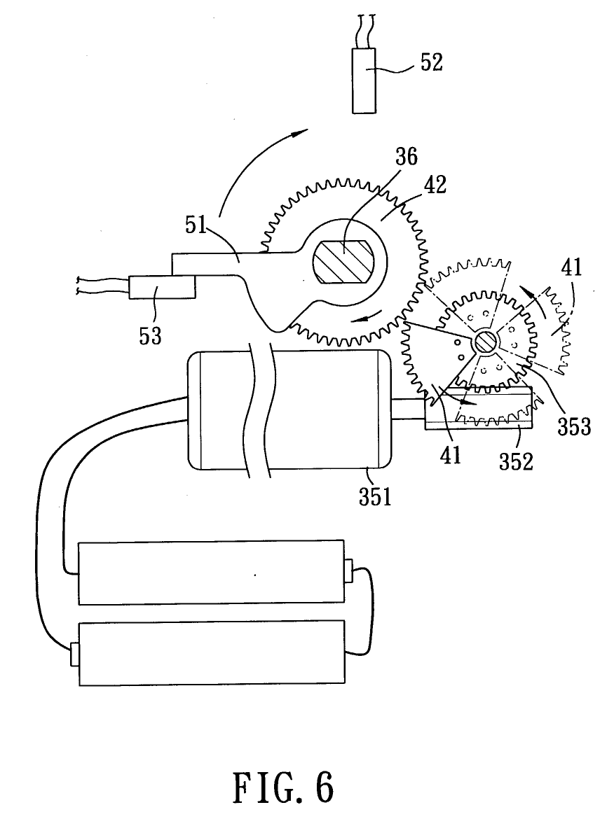

FIG. 6 illustrates a state where the motor unit 351 is activated after operating the operating member 34 to drive rotation of the spindle 36 from the second position to the first position. Unlike the foregoing description in connection with FIG. 5, activation of the motor unit 36 results in counter-clockwise rotation of the gear wheel 353 by an angle of 360 degrees when moving the spindle 36 from the first position to the second position.

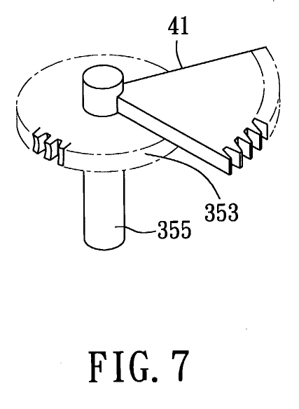

Referring to FIG. 7, in the second preferred embodiment of an electric door lock according to the present invention, the sector gear 41 is formed integrally with the shaft 355 of the gear wheel 353.

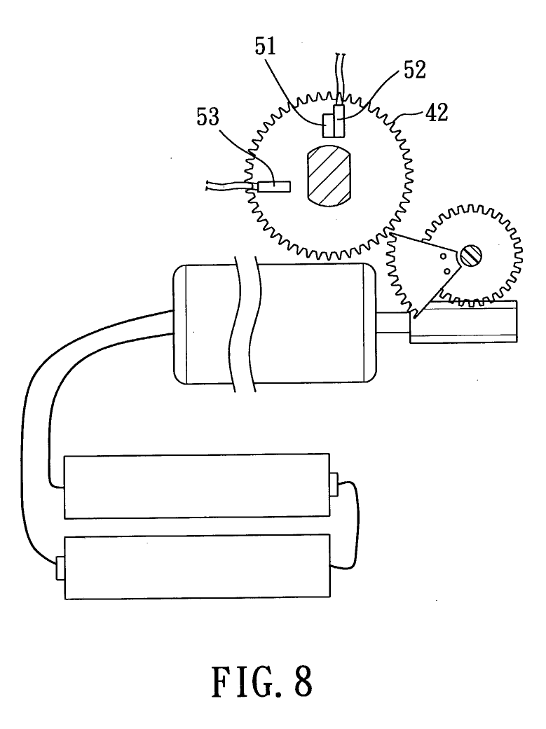

FIG. 8 shows the third preferred embodiment of an electric door lock according to the present invention. This embodiment differs from the first embodiment in that the switch actuator 51 is formed integrally on the toothed wheel 42 of the driven member.

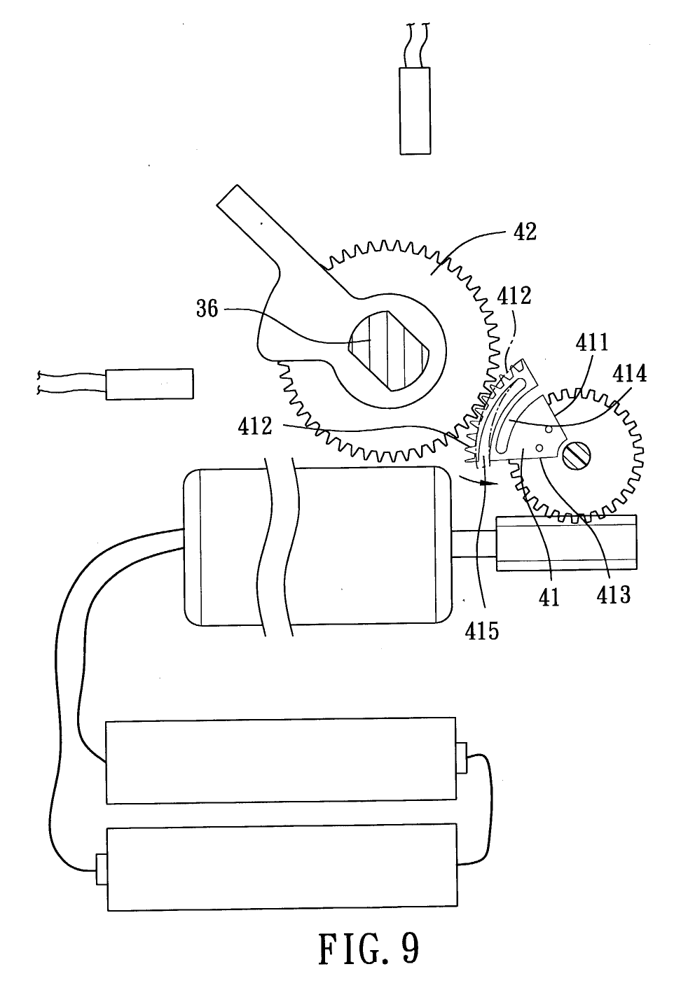

FIG. 9 shows the fourth preferred embodiment of an electric door lock according to the present invention. This embodiment differs from the first embodiment in that the sector gear 41 is formed with first and second cutouts 414, 415 adjacent to the curved peripheral side 412. The first cutout 414 extends in a circumferential direction from the first lateral side 411 toward the second lateral side 413. The second cutout 415 similarly extends in the circumferential direction but from the second lateral side 413 toward the first lateral side 411. The construction as such allows the sector gear 41 to be inherently resilient. Therefore, when the gear teeth of the sector gear 41 mesh with the gear teeth of the toothed wheel 42, and when the motor unit 351 is unable to operate due to lack of battery power, the operating member 34 (see FIG. 1) can be operated, using a relatively higher rotating force, to drive rotation of the spindle 36 from one of the first and second positions to the other of the first and second positions. This enables the gear teeth of the toothed wheel 42 to move out of engagement with the gear teeth of the sector gear 41 by forcing the gear teeth of the sector gear 41 away from the gear teeth of the toothed wheel 42 against the inherent biasing action of the sector gear 41.

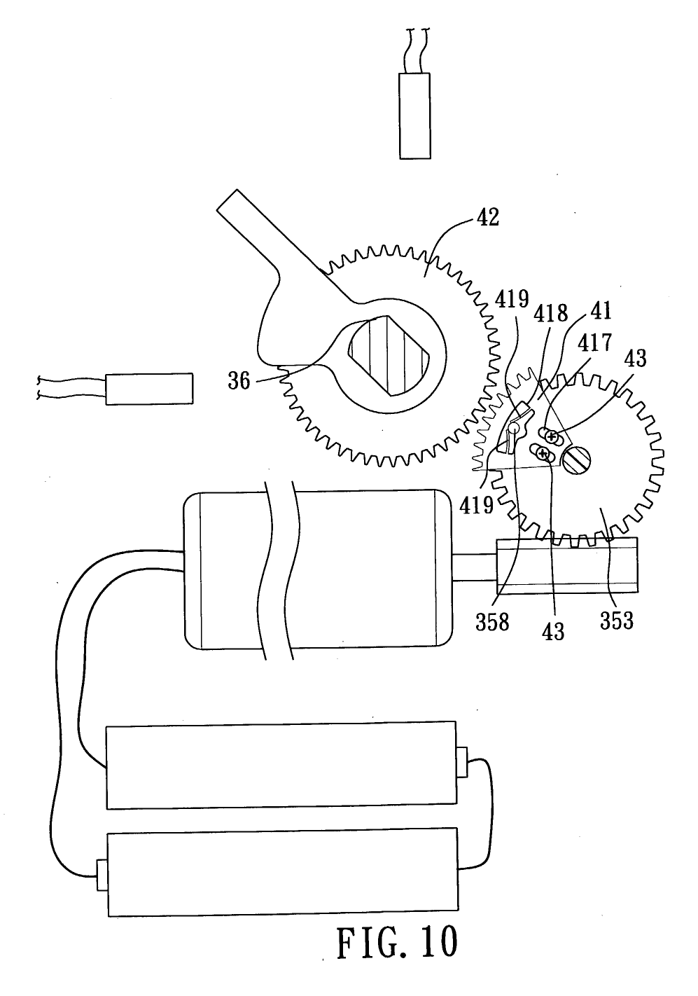

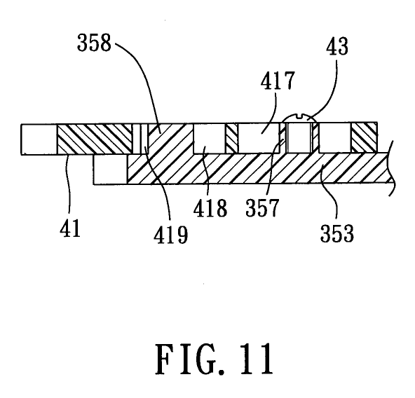

FIGS. 10 and 11 show the fifth preferred embodiment of an electric door lock according to the present invention. This embodiment differs from the first embodiment in that the sector gear 41 is mounted movably on the gearwheel 353 and is movable in a radial direction toward and away from the toothed wheel 42 of the driven member. In particular, the sector gear 41 is formed with a pair of slide slots 417 extending parallel to the radial direction, and the gear wheel 353 is formed with a pair of guide pins 357 that extend respectively into the slide slots 417 to guide movement of the sector gear 41 in the radial direction. Each of the guide pins 357 is formed with a threaded hole. Screws 43 are threaded into the threaded holes in the guide pins 357 so as to prevent removal of the sector gear 41 from the gear wheel 353.

In this embodiment, the coupling mechanism further includes an urging unit provided on the gear wheel 353 and the sector gear 41 for biasing the sector gear 41 toward the toothed wheel 42 of the driven member. In particular, the urging unit includes a positioning slot 418 formed through the sector gear 41. The positioning slot 418 is defined by a periphery that has first and second ends opposite to each other in the circumferential direction. A biased pin 358 is formed on the gear wheel 353 and extends into the positioning slot 418. First and second leaf springs 419 extend integrally and respectively from the first and second ends of the periphery of the positioning slot 418 of the sector gear 41 into the positioning slot 418 and abut against the biased pin 358.

It has thus been shown that the electric door lock 3 of this invention includes a driving member connected to a motor unit 351 and a driven member connected to a spindle 36. The arrangement as such reduces the number of components to facilitate assembly and to result in lower manufacturing costs.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electric door lock for a door panel, said electric door lock comprising:
a deadbolt adapted to be mounted on the door panel and operable for movement between d locking position, where said deadbolt is extended relative to the door panel, and an unlocking position, where said deadbolt is retracted relative to the door panel;
a deadbolt operating spindle coupled to said deadbolt and rotatable between a first position, where said deadbolt is at the locking position, and a second position, where said deadbolt is at the unlocking position;
a manual operating member coupled to said spindle and manually operable so as to drive rotation of said spindle;
an electric driving motor unit adapted to be mounted on the door panel and operable so as to provide a rotary drive force; and
a coupling mechanism adapted to be mounted on the door panel and including a driving member connected to said motor unit and a driven member connected to said spindle,
said driving member being configured to engage said driven member so as to transmit the rotary drive force of said motor unit to said spindle when said motor unit is operated for moving said spindle from one of the first and second positions to the other of the first and second positions, and being configured to disengage from said driven member when said spindle has been moved from said one of the first and second positions to the other of the first and second positions.

2. The electric door lock as claimed in claim 1, wherein said driving member includes a sector gear having first and second lateral sides spaced apart angularly from each other, and a curved peripheral side formed with gear teeth.

3. The electric door lock as claimed in claim 2, wherein said motor unit includes a gear wheel having an outer peripheral edge formed with gear teeth,
said sector gear being coupled to said gear wheel such that said sector gear rotates coaxially with said gear wheel and such that said curved peripheral side of said sector gear extends radially and outwardly beyond said outer peripheral edge of said gear wheel.

4. The electric door lock as claimed in claim 3, wherein said motor unit further includes a transmission shaft formed with a worm gear that meshes with said gear teeth of said gear wheel.

5. The electric door lock as claimed in claim 2, wherein said driven member includes a toothed wheel having an outer peripheral surface formed with gear teeth for meshing with said gear teeth of said sector gear.

6. The electric door lock as claimed in claim 2, wherein the first and second positions of said spindle are angularly spaced apart from each other by an angle of 90 degrees.

7. The electric door lock as claimed in claim 6, wherein said first and second lateral sides of said sector gear are spaced apart by an angle less than 90 degrees.

8. The electric door lock as claimed in claim 7, wherein said first and second lateral sides of said sector gear are spaced apart by an angle of 75 degrees.

9. The electric door lock as claimed in claim 1, further comprising control means for controlling deactivation of said motor unit when said spindle has been moved from said one of the first and second positions to the other of the first and second positions.

10. The electric door lock as claimed in claim 9, wherein said control means includes:
a contact switch connected electrically to said motor unit and operable so as to deactivate said motor unit when actuated; and
a switch actuator rotatable with said spindle and capable of actuating said contact switch when said spindle is at either of the first and second positions.

11. The electric door lock as claimed in claim 10, wherein said switch actuator is mounted on said spindle.

12. The electric door lock as claimed in claim 10, wherein said switch actuator is formed on said driven member.

13. The electric door lock as claimed in claim 2, wherein said sector gear is formed with at least one cutout that extends in a circumferential direction from one of said first and second lateral sides toward the other of said first and second lateral sides.

14. The electric door lock as claimed in claim 3, wherein said sector gear is mounted movably on said gear wheel and is movable in a radial direction toward and away from said driven member.

15. The electric door lock as claimed in claim 14, wherein said coupling mechanism further includes an urging unit provided on said gear wheel and said sector gear for biasing said sector gear toward said driven member.

16. The electric door lock as claimed in claim 15, wherein said urging unit includes:
a positioning slot formed through said sector gear;
a biased pin formed on said gear wheel and extending into said positioning slot; and
at least one leaf spring extending integrally from said sector gear into said positioning slot and abutting against said biased pin.

17. The electric door lock as claimed in claim 14, wherein said sector gear is formed with at least one slide slot that extends parallel to the radial direction, and said gear wheel is formed with at least one guide pin that extends into a corresponding said slide slot to guide movement of said sector gear in the radial direction.
